(19) United States
(12) Patent Application Publication
(10) Pub. No.: US 2014/0108400 A1
(43) Pub. Date: Apr. 17, 2014

(54) SYSTEM AND METHOD FOR STORING AND ACCESSING MEMORABILIA

(71) Applicant: George A. Castineiras, Farmington, CT (US)

(72) Inventor: George A. Castineiras, Farmington, CT (US)

(21) Appl. No.: 14/045,666

(22) Filed: Oct. 3, 2013

Related U.S. Application Data
(63) Continuation-in-part of application No. 13/495,450, filed on Jun. 13, 2012.

(51) Int. Cl. G06F 17/30

(52) U.S. Cl. CPC G06F 17/3007
USPC 707/736

(57) ABSTRACT

A computer based system for management of memorabilia including a processor coupled to memory and an input-output controller, a data store in communication with the processor, an input device coupled to the input-output controller and a display device coupled to the input-output controller. The memory includes at least one algorithm comprising an initial processing section configured to upload a plurality of images and audio files having a plurality of data file formats. The memory includes an organization and storage section configured to determine at least one location within the data store for storage of each of the plurality of images and audio files. The memory also includes an access and display section configured for at least one of creating, retrieving, viewing, moving, annotating and transmitting the images and audio files.

### CROSS REFERENCE TO RELATED APPLICATIONS

This application claims priority to and is a continuation-in-part of copending, commonly owned U.S. patent application Ser. No. 13/495,450, filed Jun. 13, 2012 (Attorney Docket No. 7627-0048-1), the disclosure of which is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

The present invention relates generally to a social media application for uploading, storing, organizing, enhancing, and displaying electronic representations of memorabilia and, in particular, to a computer based system which stores, organizes and displays the electronic representations of memorabilia, based on the type of memorabilia and input from the user, in electronic storage bins.

2. Description of Related Art

Some people collect and accumulate memorabilia commemorating events that have had significance during their lifetime. Such memorabilia can include a child's artwork, photographs from a vacation, an acceptance letter to a college, a sound recording, a video recording, work from school projects, a child's report card, a copy of a winning lottery ticket and first imprints of a child's hands or feet, or the like.

Some people display the memorabilia by, for example, securing the memorabilia to their refrigerator with one or more magnets. Over time, collection of the memorabilia can cause clutter. As a result of the clutter, some people store the memorabilia in boxes or bins and others discard it. The amount of memorabilia can become so extensive that it becomes difficult to access, sort through, view, share, listen to and/or display. For example, finding and viewing hard copy photo albums and finding and playing home movies can be a cumbersome and time consuming task. In addition, the capture of still images and video is typically done independent of one another and once created, cannot be easily altered or edited. As a result, the essence, meaning, story line or sense of a moment or event captured in a still image, video or audio recording is lost.

### SUMMARY OF THE INVENTION

According to aspects illustrated herein, there is provided a computer based system for management of memorabilia including a processor coupled to memory and an input-output controller, a data store in communication with the processor, an input device coupled to the input-output controller and a display device coupled to the input-output controller. The memory includes at least one algorithm comprising an initial processing section configured to upload a plurality of memorabilia including images and audio files having a plurality of data file formats. The memory includes an organization and storage section configured to determine at least one location within the data store for storage of each of the plurality of memorabilia, e.g., still images, photos, artwork, videos and audio files. The memory also includes an access and display section configured for at least one of creating, retrieving, viewing, moving, arranging, annotating and transmitting the memorabilia files.

### BRIEF DESCRIPTION OF THE DRAWINGS

FIG. 1 is a simplified schematic block diagram of a computer based system for management of memorabilia, in accordance with one embodiment of the present invention;

FIG. 2 is a schematic illustration of memorabilia management algorithms (MMA) of the computer based system for management of memorabilia of FIG. 1;

FIG. 3 is a schematic illustration of an initial processing section of the MMA of FIG. 2;

FIG. 4 is a schematic illustration of an access and display section of MMA of FIG. 2;

FIG. 5 is a representation of a graphical user interface depicting a Main or Navigation interface of the MMA of FIG. 2;

FIG. 6 is a representation of a graphical user interface of the MMA of FIG. 2 depicting adding an audio comment on an item of memorabilia;

FIG. 7 is a representation of a graphical user interface of the MMA of FIG. 2 depicting a process for adding sound effects to an item of memorabilia;

FIG. 8 is a representation of a graphical user interface of the MMA of FIG. 2 depicting a process for adding a doodle to an item of memorabilia;

FIG. 9 is a representation of a graphical user interface of the MMA of FIG. 2 depicting a process for uploading an item of memorabilia;

FIG. 10 is a representation of a graphical user interface of the MMA of FIG. 2 depicting processes for creating and editing a data storage bin such as a STORYBOX™ storage location;

FIG. 11 is a representation of a graphical user interface of the MMA of FIG. 2 depicting a plurality of STORYBOX™ storage locations of a particular user;

FIGS. 12 and 12A are representations of a graphical user interface of the MMA of FIG. 2 depicting embodiments for presenting a plurality of related memorabilia within STORYBOX™ storage locations; and

FIG. 13 is a representation of a graphical user interface of the MMA of FIG. 2 depicting a process for adding a video comment on an item of memorabilia.

### DETAILED DESCRIPTION OF PREFERRED EMBODIMENT OF THE INVENTION

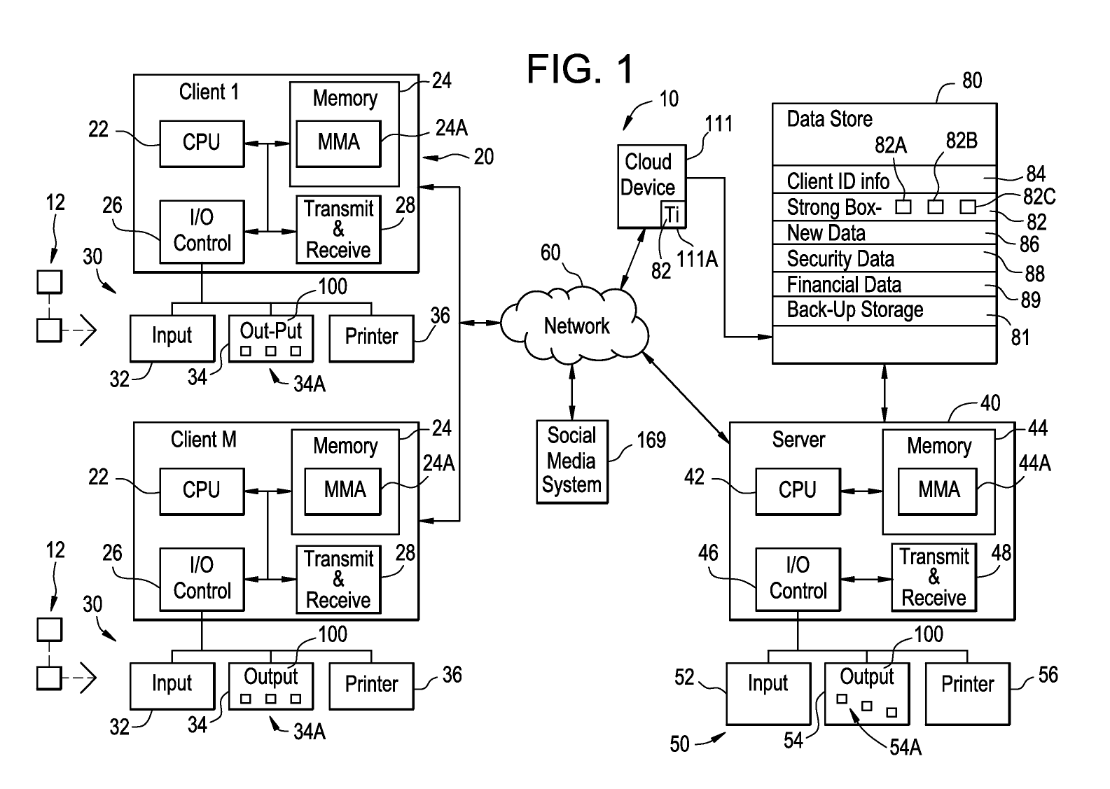

Referring to FIG. 1, the present invention provides a novel computer based system 10 for management of memorabilia (hereinafter the memorabilia management system 10), which stores, organizes, plays, broadcasts and displays memorabilia 12 such as but not limited to electronic representations of memorabilia including photographs, video recordings, audio recordings, any form, appearance, semblance, physical likeness or representation of a person, animal, or thing, photographed, drawn, painted, sculptured, or otherwise made visible; and stores, organizes, plays and broadcasts audio recordings, such as but not limited to audio files. The memorabilia 12 may include items such as a child's artwork, photographs from a vacation, an acceptance letter to a college, a sound recording such as voice and/or music, a video recording, photographs, work from school projects, a child's report card, a copy of a winning lottery ticket and first imprints of a child's hands or feet.

In one embodiment, the memorabilia management system 10 is referred to as a MOMENTAGE™ system which provides computer-implemented tools and methods including an application (“app”) based solution executable by, for example, a portable computing device, and a web site that gives users the ability to upload, store, view, organize, enhance, digitize, alter, comment upon, exchange, share and display memorabilia 12 such as, but not limited to, photographs, artwork, video and audio works in a data store and/or portions thereof such as, but not limited to a STORYBOX™ or STORYBIN™ location, including one or more collections or collages of MOMENTS™; and to print and generate two and three dimensional replicas, objects and designs of artwork and photographs, and to generate video and audio recordings and files. MOMENTAGE™ (U.S. Trademark Application Serial No. 85/642,332, filed Jun. 4, 2012); STORYBOX™ (U.S. Trademark Application Serial No. 85/642,362, filed Jun. 4, 2012); STORYBIN™ (U.S. Trademark Application Serial No. 85/642,409, filed Jun. 4, 2012); and MOMENTS™ are trademarks of Castineiras Companies, LLC of 270 Farmington Avenue, Farmington, Conn. 06032, USA.

As described herein, the memorabilia management system 10 includes the following and other features and functions implemented as tools and/or methods with the system 10 to process the memorabilia 12, including:

1. A single smartphone application (App) with an integrated computer interface that cooperate to capture, immediately organize and display the memorabilia 12 such as still images and/or perform audio and video recordings.

2. A memorabilia management system that is configured for on-line, point-of-capture, and remote creation of, uploading data to and access to a plurality of data storage bins, for example, STORYBOX™ storage locations, identified by icons and/or indicia and that store electronic representations of the memorabilia 12 including images, audio and video in various segmentable user defined compartments or categories, such as but not limited to holidays, baby, school, sports, art and crafts, vacations and new still images, audio and video.

3. A memorabilia management system that is configured to accept and integrate multiple formats of digitized memorabilia 12 including still images, audio, video and still images with text, still image, video and audio annotations and comments.

4. Single point control such as but not limited to “play button” initiation, selection and control of display and performance of the memorabilia 12 including still images, audio, video and still images with text, still image, video and audio annotations and comments.

5. Automatic updating, sorting and populating of the data stores and/or STORYBOX™ locations triggered by the creation of memorabilia 12 including a still image (e.g., taking of a photograph), uploading of a scanned image, recording of video images and/or recording of audio data or by user commands.

6. Selective transmission and sharing of electronic representations of the memorabilia 12 including images, audio, video and still images with text, still image, video and audio annotations and comments to and with a predetermined population.

7. Configured to communicate with and receive the memorabilia 12 including images, audio, video and still images with text, still image, video and audio annotations and comments from a plurality of predetermined sources, either simultaneously or sequentially.

8. Cloud based secure storage of the memorabilia 12 including images, audio, video and still images with text, still image, video and audio annotations and comments, for access via wired or wireless communication links from multiple locations at any time.

9. Packaging of the contents of or preselected portions of the data store and/or STORYBOX™ locations for distribution and/or sale for retail purposes, fundraising activities and/or gifts, or the like.

10. The ability to transform all or portions of the memorabilia 12 including still images, audio recordings (e.g., digital electronic recordings including voices and/or music and the like) and video recordings (e.g., digital electronic recordings) into two or three dimensional objects and to distribute the same to predetermined recipients.

11. The ability to link to social media systems (e.g., FACEBOOK® and TWITTER®) to present a tiered pricing structure for access to and use of the services and products made available via the memorabilia management system 10.

12. The memorabilia management system 10 includes a capture verification module that is configured to verify a successful upload of the memorabilia 12, for example, the images, such as the still images, the audio recordings, and the video recordings are captured and stored in the storage bins (e.g., STORYBOX™ locations) and to generate a delete permissive signal to prompt deletion of the still images, audio recordings, and video recordings from a device which captured them (e.g., a camera or a smart phone such as, but not limited to an iPhone™ from Apple Inc., Nokia's Symbian™, Motorola's Droid™ and Windows Mobile™ phones, Google's Android™ phone and Linux phones or the like).

13. The memorabilia management system 10 provides image, video and/or audio capture, edit, annotation, storage, displaying and playing the images, the video recordings and the audio recordings in a single device, without the need for ancillary devices such as cameras, video recorders, photo albums, CDs, DVDs, CD and DVD players and the like.

14. The memorabilia management system 10 provides back-up storage capability in multiple remote locations to prevent loss of the memorabilia 12 including the images, the video recordings and the audio recordings, for example due to fire, theft or the like.

Referring to FIG. 1, the memorabilia management system 10 is configured to create, store, organize and display electronic representations of the memorabilia 12 in a storage device such as a data store 80 or portion thereof referred to as, for example, a STORYBOX™ location or a virtual electronic museum including one or more collections or collages of MOMENTS™, namely, related memorabilia 12 documenting, for example, an event, as described below. The memorabilia management system 10 includes a plurality of client devices (e.g., Client 1-M), shown generally at 20, operatively coupled to a server device 40 over a communication network 60 such as, for example, the Internet, an intranet, an extranet, or like distributed communication platform connecting computing devices over wired and/or wireless communication connections. In one embodiment, the STORYBOX™ locations and one or more MOMENTS™ therein, are accessible for viewing or listening via a single activation, for example via activation of a play button such as a click on button on a display screen, as described below. As is known to those skilled in the art, the client devices 20 and the server 40 may each include a CPU or processor 22 and 42, respectively, computer-readable medium or memory 24 and 44, respectively, an input-output controller 26 and 46 operatively coupled to input-output devices 30 and 50 including devices for facilitating input of data (e.g., the memorabilia 12) to the memorabilia management system 10 such as a keyboard, a mouse, light pen pointing device, document or card reader, scanner or recording device, or other input device 32 and 52, respectively, for displaying inputted and/or processed data and other information such as a pixel-oriented display devices 34 and 54, printers 36 and 56, or the like. The client devices 20 and the server 40 include communication means such as, for example, transceivers 28 and 48, for facilitating communication over the network 60. The processors 22 and 42 execute program instructions stored in memory or provided to the processors 22 and 42 (e.g., by remotely hosted services) such that users, customers and others operating individual ones of the client devices 20 communicate over the network 60 with other client devices 20 as well as other computing devices coupled to the network, such as the server device 40. As noted above, it should be appreciated that the client devices 20 and/or server 40 include, for example, a personal computer (PC), notebook computers, netbook computers, IPads®, Nooks™, workstations, laptops, tablet computer, personal digital assistant, pocket PC, Internet-enabled mobile radiotelephone, a smart phone such as, but not limited to an iPhone™ from Apple Inc., Nokia's Symbian™, Motorola's Droid™ and Windows Mobile™ phones, Google's Android™ phone and Linux phones, pager or like portable computing devices.

As shown in FIG. 1, the server 40 is coupled to a data store 80. It should be appreciated that the data store 80 may be a relational data base, object oriented data base, a virtual electronic museum or other suitable data repository, as is known in the art. In one embodiment, the data store 80 includes one or more records, tables and/or data bases for storing information, data, programming parameters and/or variables employed within the memorabilia management system 10. For example, the data store 80 may include a plurality of STORYBOX™ locations or categories 82 identified with names such as sports 82A, baby 82B and school 82C, which may include one or more MOMENTS™ of one or more electronic representations of memorabilia 12. In one embodiment, the data store 80 includes a section, a bin or portion thereof, for client identification information 84 (e.g., name, address, phone number, e-mail address, etc.), new data 86, security data 88 (e.g., passwords, user IDs, etc.) and financial data 89 (e.g., pricing, revenue, costs, billing and payment information). The data store 80 includes a first back-up storage section 81 for redundant storage of the images, the video recordings and the audio recordings. In one embodiment, the memorabilia management system 10 includes a cloud device 111 in communication with the network 60 and the data store 80. It should be appreciated that as used herein a “cloud” device is a computing device that is connected to a real-time distributed communication network, such as network 60, and includes physical and virtual hardware devices. The cloud device 111 includes a second back-up storage section 111A for redundant storage of the memorabilia 12 including the images, the video recordings and the audio recordings in a STORYBOX™ location 82 or MOMEN™ therein.

In one embodiment, the server 40 of the memorabilia management system 10 is located at the cloud device 111 or site providing computer services to a plurality of users, subscribers or members of the system 10. In one embodiment, the server 40 and/or the data store 80 are cloud computing devices. The one or more client devices 20 include computing devices operated by the one or more users, subscribers or members that are accessing the features and functions of the memorabilia management system 10 (described herein) in locations that are remote from the server 40, via the network 60.

The processors 22 and 42 execute computer-implemented steps and/or algorithms for memorabilia management 24A and 44A (hereinafter memorabilia management algorithms (MMA) 24A and 44A) stored in the memory 24 and 44 of, or otherwise provided to, the client devices 20 and the server 40, respectively. A person (e.g., one or more users, subscribers or members) operating the memorabilia management system 10 may execute the MMA 24A and 44A, to access the memorabilia 12 such as, for example, to view still images, audio and video recordings outputted, for example, exhibited on the display device or display devices coupled to their computing devices (e.g., the display devices 34 and 54), and create and name STORYBOX™ locations and/or MOMENTS™ therein, upload, arrange, and comment on the memorabilia 12 including, for example, the still images, audio and video recordings and share the still images, audio and video recordings and comments annotated therewith with a plurality of predetermined entities, as described in further detail herein. It should be appreciated that the MMA 24A and 44A generally require manipulation of data in the form of electrical, magnetic and/or optical signals that may be inputted, stored, transferred, combined, compared, or otherwise manipulated to provide a desired result. For example, the MMA 24A and 44A may direct the processors 22 and 42, the input-output controllers 26 and 56, and/or the displays 34 and 54 to exhibit one or more user interfaces, e.g., application generated user interfaces, web pages, and the like, shown generally at 34A and 54A. Exemplary user interfaces 34A and 54A depicting the computer based system 10 and MMA 24A and 44A, are described below.

In one embodiment, the server 40 hosts the user interfaces 54A such as a home page and other web pages or a mobile phone App, that are requested by the user through designation of a Uniform Resource Locator (URL) identifying the web pages and providing access to the server 40 from other computing devices (e.g., the client devices 20) on the network 60. In one embodiment, access to the web pages 54A, server 40, data store 80, selected portions thereof, and/or to selected services and functionality provided by the memorabilia management system 10, is restricted to registered or otherwise authorized users, administrators and others, as is described below. The client devices 20 execute programs such as, for example, web browser software to request, receive and process the web pages 54A from the server 40, for example, as web pages 34A exhibited on the display devices 34 of the client devices 20. The web pages 34A and 54A are generally written in a language that permits a graphical presentation of the memorabilia 12 (e.g., text, images, audio, video, and the like) and/or other information to persons operating a computing device such as one of the client devices 20. Languages include, for example, the Hyper-Text Markup Language (HTML), Extensible Markup Language (XML) or another Standard Generalized Markup Language (SGML), as are generally known in the art.

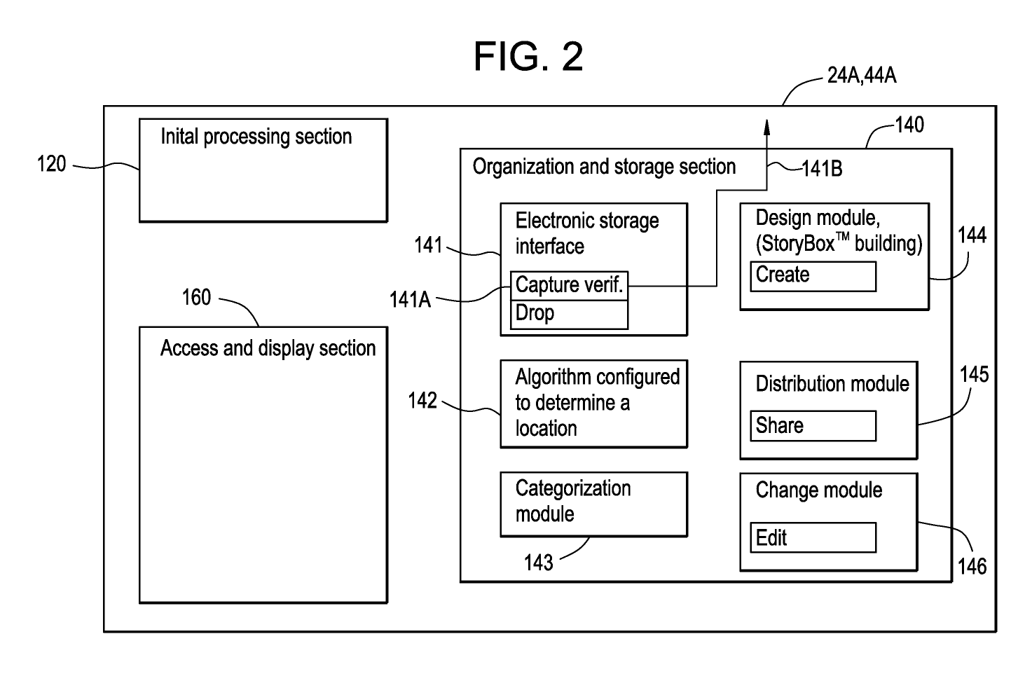

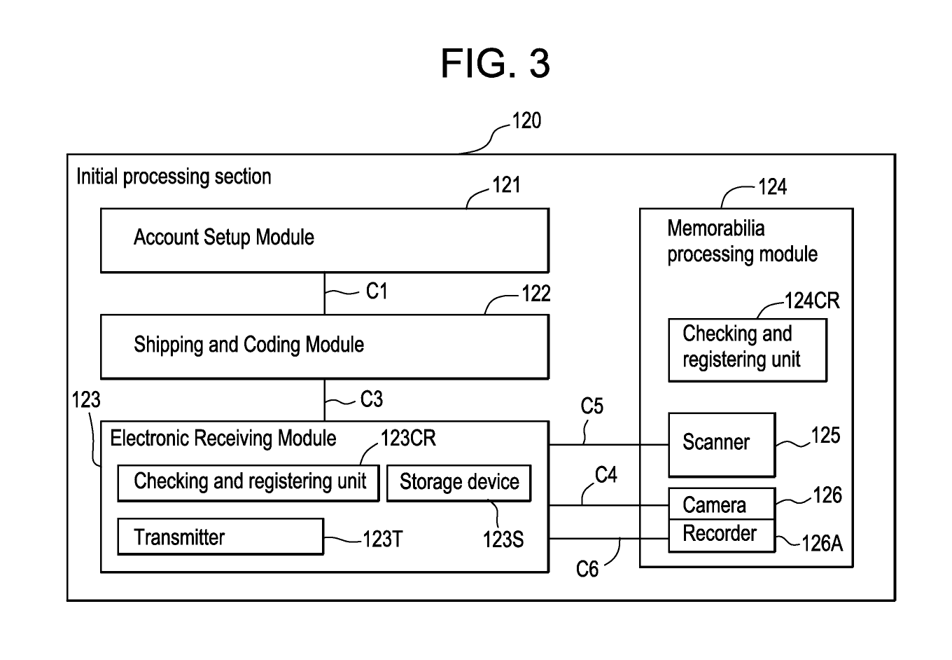

As shown in FIG. 2, the MMA 24A and 44A includes an initial processing section 120, an organization and storage section 140 and an access and display section 160. As shown in FIG. 3, the initial processing section 120 is configured to enable initial account setup and to receive the memorabilia 12 and electronically stored forms thereof. The initial processing section 120 includes an account setup module 121 which is configured to establish an account for each user, including establishing a username, password, data storage area, payment methods, e-mail communications and initial user preferences. The initial user preferences include, but are not limited to selection of a data storage size and format, display format and memorabilia transmission format. For example, the users have the option of selecting default formats or design and/or specify their own custom designed formats for data storage, data storage size and capacity expansion options, display and/or transmission of the electronic representation of the memorabilia 12. In one embodiment, the user is charged a fee for the custom designed data storage formats and/or the additional data storage capacity.

As illustrated in FIG. 3, the initial processing section 120 also includes a shipping and coding module 122 which is in communication with the account setup module 121 via a communication link C1 for transmitting the account information and permissive signals as detailed below. Communication between the shipping and coding module 122 and the users' client devices 20 is activated, after receiving a permissive signal from the account setup module 121, confirming the establishment of the respective user's account.

The shipping and coding module 122 generates coding information for use in transmitting, shipping, identifying and categorizing the memorabilia 12. The shipping and coding module 122 includes an algorithm for generating coding information, such as unique identification codes (e.g., alpha-numeric characters) that are used to identify each item of memorabilia 12. In one embodiment, the unique identification codes are automatically assigned according to characteristics of the memorabilia 12 including memorabilia format (e.g., image, sound recording, video recording, etc.), date (e.g., creation date, submittal date, event date, etc.), event type (e.g., birthday, holiday, vacation, graduation, etc.), subject (e.g., daughter, son, pet, etc.) and/or other characteristics of the memorabilia 12, identified by the user. In one embodiment, the coding information is provided in a catalogue format. The shipping and coding module 122 is configured to generate the coding information in electronic format for use in submittal of the electronic representations of the memorabilia 12 and/or in printable format (e.g., for printing on labels) for affixing to the memorabilia 12 to be shipped to a receiving area.

As shown in FIG. 3, the initial processing section 120 also includes an electronic receiving module 123, which is in communication with the shipping and coding module 122 via a communications link C3 (e.g., an internet connection), for transmitting the coding information, the account information and the permissive signals as detailed below. Communication between the electronic receiving module 123 and the client devices 20 is activated, after receiving a permissive signal from the account setup module 121, confirming the establishment of the respective user's account.

The electronic receiving module 123 is configured to receive the electronic representations of the memorabilia 12, for example e-mail or electronic messages transmitted from the client devices 20. The electronic receiving module 123 includes a storage device 123S that automatically stores the e-mails, messages (e.g., text messages, voice messages, sound recordings, etc.) and attachments thereto (pictures, videos, sound recordings, text messages, etc.), received from each particular user in a unique user designated portion of the storage device 123S, such as a unique URL. The storage device 123S is configured to store the e-mails, messages and attachments until the user decides to catalogue or organize them or until the memorabilia management system 10 automatically organizes them, as described below.

The electronic receiving module 123 includes a checking and registering unit 123CR configured to check for and register the coding information associated with the electronic representations of the memorabilia 12.

The electronic receiving module 123 also includes a transmitter 123T for transmitting the electronic representations of the memorabilia 12 to the access and display section 160 or a memorabilia processing module 124 (described below). The electronic receiving module 123 is also configured to optimize the electronic representations of the memorabilia 12, including cropping, rotating, straightening, sizing and framing the electronic representations of the memorabilia 12. In one embodiment, the receiving module 123 includes “swipe and drop” functionality to allow a user to move graphical objects or icons of the electronic representations of the memorabilia 12 within a window or between windows representing one or more of the plurality of STORYBOX™ locations 82 and/or one or more of the MOMENTS™ therein. As should be appreciated during a “swipe and drop” operation the user selects an item such as an electronic representation of memorabilia 12 represented by a graphical object by moving a mouse, other pointing device or their finger to the graphical object presented on a graphic interface, depressing one or more buttons on the mouse or pointer, or depresses the graphical object itself, and held while depressed the user moves the mouse, pointer or their finger through the graphic interface to the desired change of position, for example, for one STORYBOX™ location 82 and/or one MOMENTS™ to a next STORYBOX™ location 82 and/or one MOMENTS™. The desired change of position may simply be for a more aesthetically pleasing arrangement of the interface, or, in the case of a transfer between STORYBOX™ location 82 and/or one MOMENTS™, may represent a transfer of data between storage locations. The user then releases the button or graphic object itself to, in effect, “drop” the selected graphical object in the new position.

The initial processing section 120 also includes a memorabilia processing module 124 for processing memorabilia 12 and the electronic representations of the memorabilia 12 which do not include the coding information. The memorabilia processing module 124 is configured for creating an electronic representation of the memorabilia in a suitable format, such as a scanned image (e.g., a pdf or jpeg file), a text document (e.g., a pdf or MS Word or equivalent word processing document file), a sound recording, a video recording and/or a photograph. For example, the memorabilia processing module 124 includes equipment for creating the electronic representations of the memorabilia 12 from the memorabilia 12 shipped to the receiving area. The equipment for creating the electronic representations includes, but is not limited to, a scanner 125, a camera 126 (e.g., still camera, video camera) and a recorder 126A (e.g., audio or video recorder). In addition, the memorabilia processing module 124 includes a checking and registering unit 124CR configured to check for and register the coding information associated with the memorabilia 12. The memorabilia processing module 124 is in communication with the shipping and coding module 122 for adding the coding information to the memorabilia 12 if required.

In one embodiment, the electronic receiving module 123 is in communication with the camera 126 via the communication link C4, the scanner 125 via the communications link C5 and the recorder 126A via the communications link C6. The electronic receiving module 123 is configured to upload a plurality of images and audio files from the camera 126, the scanner 125 and the recorder 126A coincident with a point-of-capture of the images and audio files by the camera 126, the scanner 125 and/or the recorder 126A. Referring again to FIG. 2, the organization and storage section 140 and, in particular, the algorithm 142 configured to determine a location of the images, video recordings, audio recordings and audio files, is configured to determine at least one location within the data store 80 for storage of each of the plurality of images and audio files coincident with the point-of-capture of the images and audio files by the camera 126, the scanner 125 and/or the recorder 126A. Thus the possibility for misplacing, misclassifying, loosing or erasing the plurality of images and audio files in the camera 126, the scanner 125 and/or the recorder 126A or on other intermediate storage medium such as flash drives, memory cards, CD's and DVDs is minimized or eliminated.

As shown in FIG. 2, the organization and storage section 140 includes an electronic storage interface algorithm 141 for communicating with the data store 80 in which the electronic representations of the memorabilia 12 is stored. The organization and storage section 140 includes an algorithm 142 configured to determine a location (e.g., a virtual electronic wall, bin, STORYBOX™ location, floor and/or room) within the data store 80 to store each of the electronic representations of the memorabilia 12. The organization and storage section 140 includes a categorization module 143 which includes an algorithm that is configured to identify common attributes of the electronic representations of the memorabilia 12, based upon an assessment of the characteristics of the memorabilia 12 and identifies groups and sub-groups of the electronic representations of the memorabilia 12. For example, the algorithm identifies groups or MOMENTS™ such as family, which can include sub-groups of vacation, school and birthday related memorabilia 12. The electronic storage interface algorithm 141 includes a capture verification module 141A that is configured to verify that the memorabilia 12 including still images, audio recordings, and video recordings are captured and stored in the storage bins (e.g., STORYBOX™ locations) and to generate a delete permissive signal 141B to prompt deletion of the memorabilia 12, e.g., the images, audio recordings, and video recordings from the client device 20 (e.g., a smart phone, an I-phone or a camera), the camera 126, the recorder 126A or the scanner 125 which captured them after verification of the storage of the images, audio recordings, and video recordings in the STORYBOX™ locations 82 and/or one or more MOMENTS™ included therein. It should be appreciated that in accordance with one aspect of the present invention, the memorabilia management system 10 does not limit or restrict the quantity, size or run time (e.g., for audio and/or video recordings) on individual electronic representations of the memorabilia 12 that may be stored in the STORYBOX™ locations 82 and/or the one or more MOMENTS™ included therein.

The organization and storage section 140 also includes a design module 144 which includes algorithms for the creating, formatting, security coding and naming of storage bins, such as for example STORYBOX™ locations 82 and/or one or more MOMENTS™ included therein. The design module 144 includes a catalog of standard storage formats, for example a plurality of graphical roadmaps of various virtual electronic museums, storage bins or STORYBOX™ locations. The catalog of standard storage formats includes identification of electronic museum rooms and indicia such as icons or drop down menus which indicate the contents of each museum room. The organization and storage section 140 also includes a distribution module 145 which automatically places the electronic representations of the memorabilia 12 in one or more of the electronic museum rooms, storage bins, STORYBOX™ locations 82 or walls, based on predetermined criteria. The distribution module 145 is configured to share and transmit the electronic representations of the memorabilia 12 including the still images, audio and video recordings to predetermined users upon receipt of commands and/or automatically in response to predetermined criteria (e.g., a list of e-mail addresses and/or names of people). The organization and storage section 140 also includes a change module 146 which enables changing, editing, renaming or adding electronic museum rooms, storage bins or STORYBOX™ locations 82 in which the electronic representations of the memorabilia 12 is stored. Such changing of or adding museum rooms, storage bins or STORYBOX™ locations 82 may result in a fee charged to the user. The change module 146 is also configured to set a frequency, time and date that the electronic representations of the memorabilia 12 can be displayed. For example, certain electronic representations of the memorabilia 12 can be selected for continuous or periodic display during a particular holiday season.

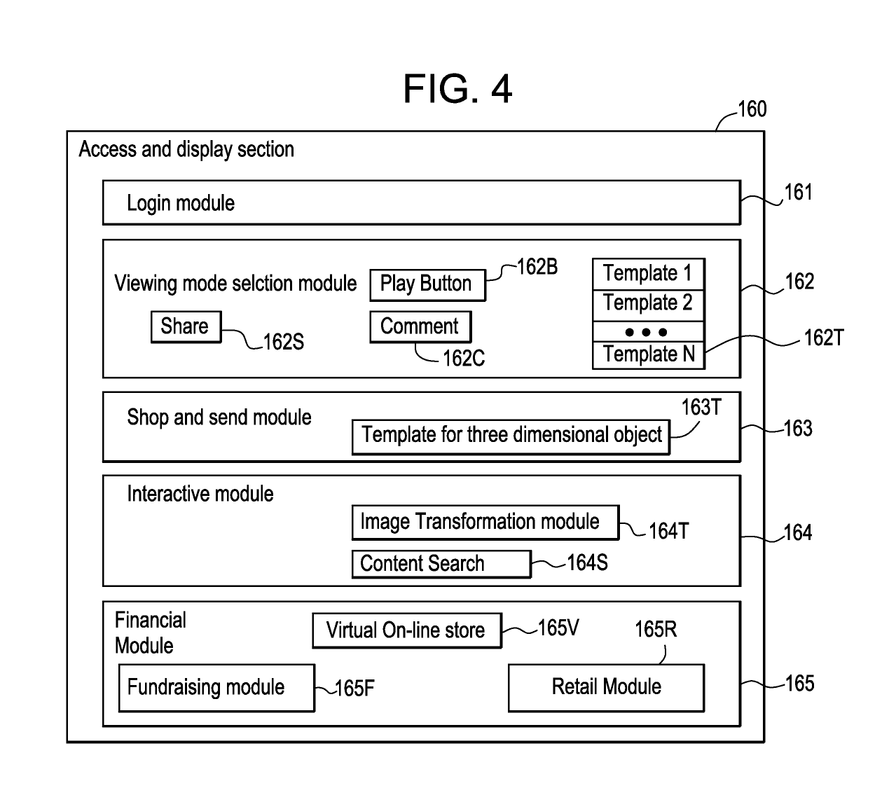

Referring to FIG. 4, the access and display section 160 is configured for retrieving, creating, viewing, moving and arranging (e.g., using the aforementioned “swipe and drop” functionality), and transmitting the electronic representations of the memorabilia 12. For example, the electronic representations of the memorabilia 12 are retrieved from, created, moved, arranged and viewed in, and transmitted to and from the electronic storage device 141 (e.g., the virtual electronic museum, the storage bin or the STORYBOX™ locations 82). In one embodiment, as the electronic representations of the memorabilia 12 is transmitted between the server 40 and the one or more client devices 20 the memorabilia management system 10 may employ various compression and/or decompression algorithms. It should be appreciated the compression and/or decompression algorithms are used to ensure efficient communication between the server 40 and the client devices 20 and to, for example, reduce redundancies, maximize bandwidth and like system concerns that may cause undue delay in communication between the devices.

In one embodiment, the access and display section 160 includes a login module 161, a viewing mode selection module 162, a shop and send module 163 and an interactive module 164 interconnected with one another via suitable communication links. The login module 161 is configured to request the users' username and password, compare the username and password to those established in the initial processing section 120 and authorizing access to portions of the memorabilia management system 10. For example, the login module 161 authorizes access to the viewing mode selection module 162, the shop and send module 163 and the interactive module 164. In one embodiment, the access and display section 160 includes a financial module 165 having a virtual on-line store module 165V, a fundraising module 165F and a retail module 165R. The login module 161 also can authorize access to the fundraising module 165F.

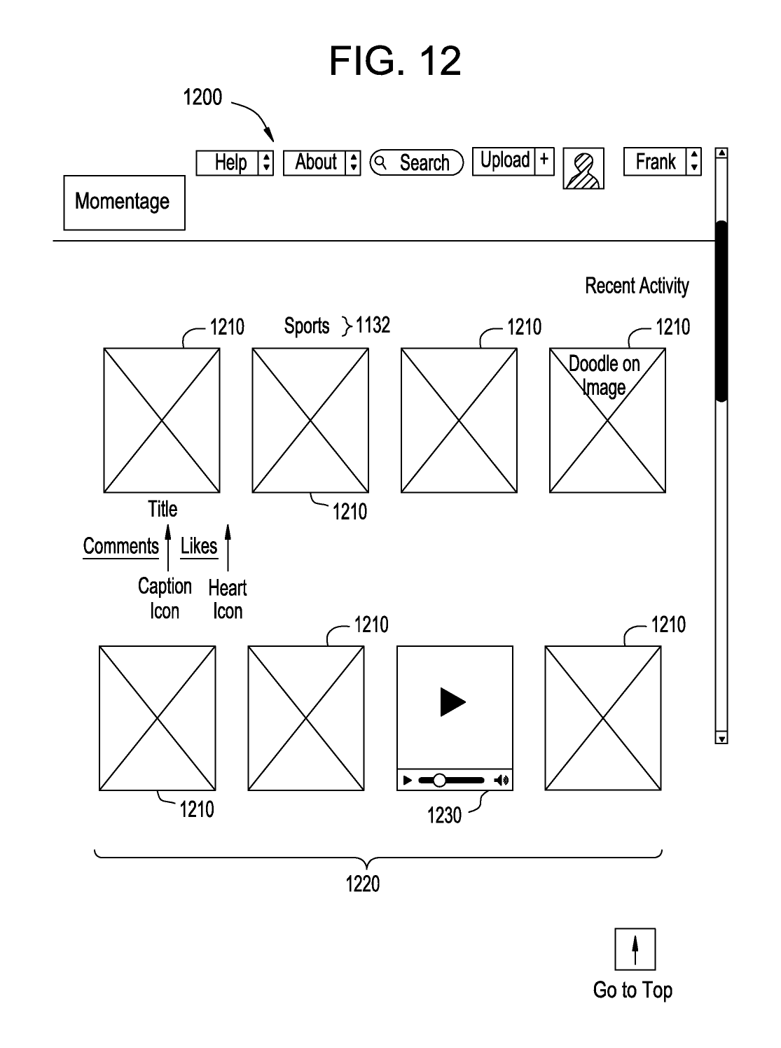

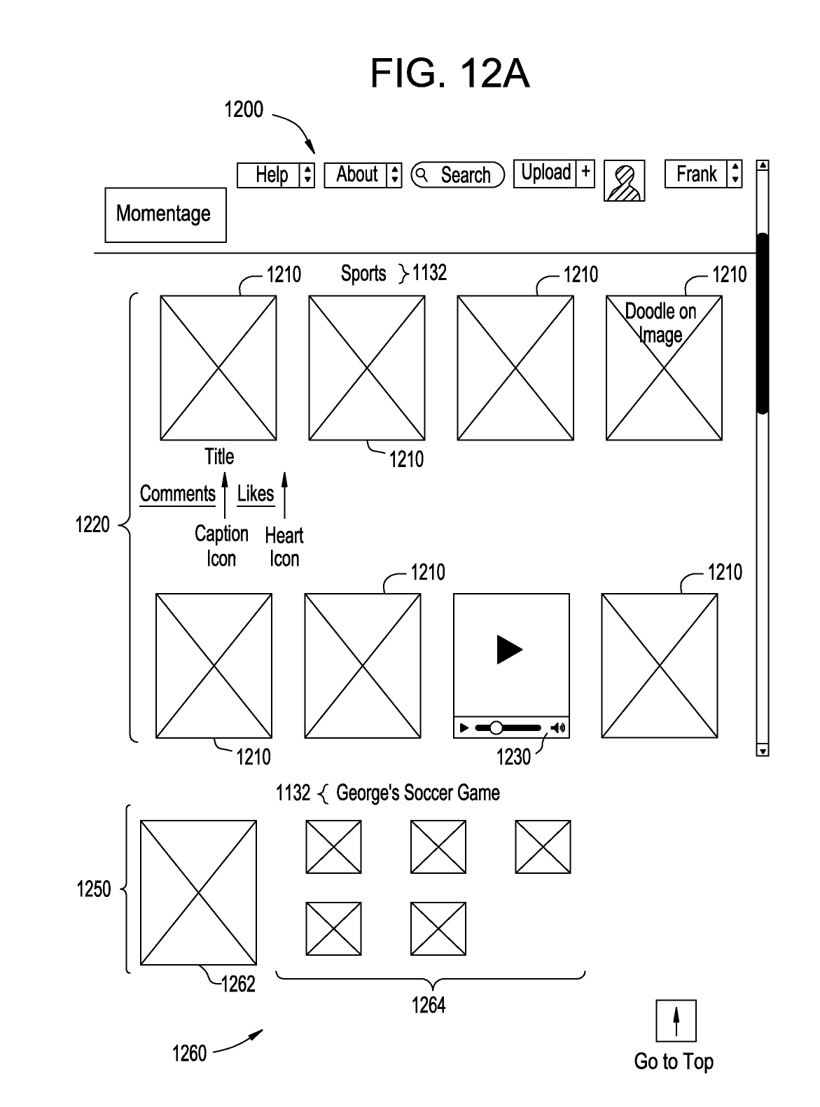

In one embodiment, the viewing mode selection module 162 includes a browse setting which allows the user to select and view the electronic representations of the memorabilia 12 at the discretion of the user. The viewing mode selection module 162 also includes an automatic setting which triggers a random or predetermined display of the electronic representations of the memorabilia 12. In one embodiment, the viewing mode selection module 162 includes a plurality of templates 162T that each defines, for example, a format or grid by which the electronic representations of the memorabilia 12 are displayed on the client device 20 when selected. In one embodiment, when two or more of the electronic representations of the memorabilia 12 are stored in a STORYBOX™ location 82 and/or one or more MOMENTS™ included therein, the representation of the memorabilia 12 is exhibited in one of a plurality of predefined grid patterns in the templates 162T. For example, in one grid pattern a first electronic representation of the memorabilia 12 is exhibited in an enlarged format relative to second or more electronic representations of the memorabilia 12 in the grid pattern (FIG. 12A, described below).

In one embodiment, the viewing mode selection module 162 also includes a user preference selector (not shown) which enables the user to select viewing preferences and commands such as, but not limited to adjusting contrast, color, volume, size and orientation; adjusting special effects, such as animation and three dimensional effects; printing; e-mailing; and playing, pausing, fast forwarding and reversing videos, of the electronic representations of the memorabilia 12. The viewing mode selection module 162 includes a play button 162B which is configured to be activated by a user to initiate display and/or performance of the electronic representations of the memorabilia 12 including the still images, audio, video and combinations thereof and contents of the data store 80 (e.g., one or more STORYBOX™ locations 82) in chronological sequence or a predetermined sequence, speed, volume, order and direction, in one or more steps (e.g., viewing sequences or sweeps). The viewing mode selection module 162 may also include a share button 162S which is configured to be activated by the user to share and transmit the electronic representations of the memorabilia 12 including the still images, audio, video and combinations thereof and contents of the data store 80 (e.g., one or more STORYBOX™ locations 82) to one or more predetermined users, addresses, FACEBOOK® friends or the like. The viewing mode selection module 162 includes a comment button 162C which is configured to be activated by a user to comment on or add to the electronic representations of the memorabilia 12 including adding audio, video, text, doodles and/or still images to other ones of the electronic representations of the memorabilia 12 including audio, video, text, doodles and/or still images.

The shop and send module 163 includes a catalog and order processing section (not shown) which is configured to enable the user to select and purchase one or more of the electronic representations of the memorabilia 12 including coloring books (e.g., three dimensional coloring books), access to electronic coloring books (e.g., electronic three dimensional coloring books, on-line art tools and three dimensional illustration software), three dimensional renditions of the electronic representations of the memorabilia 12 (e.g., three dimensional figures created by a three dimensional printer), accessories (e.g., microphones, recording devices, voice recording software and art forms) and custom designed postage (e.g., ARTSTAMPS® https://www.artstamps.com/). In one embodiment, the shop and send module 163 includes a template section 163T for ordering and purchasing templates, for example, models, body parts, structural components and patterns for creating three dimensional objects, such as three dimensional renditions of memorabilia 12 and figurines. The users can assemble, paint, dress or otherwise decorate the three dimensional objects.

The interactive module 164 includes a module for initiating and conducting contests, including submitting and tallying surveys and/or votes, collecting contest fees, announcing contest winners and awarding prizes, for example monetary awards. The interactive module 164 also includes a module for enabling authorized users to comment on and or annotate the electronic representations of the memorabilia 12. The interactive module 164 also includes a module for the online electronic creation of and/or remote submittal of memorabilia 12 from, for example, client devices 20. In addition, the interactive module 164 is configured for users to create electronic three dimensional images using conventional three-dimensional illustration software. The interactive module 164 is in communication with the shop and send module 163 to enable the user to save the three dimensional images in electronic format in the viewing and selection module 162. In one embodiment, the interactive module 164 is in communication with the shop and send module 163 to enable the user to purchase, create (e.g., via a printer configured to create three dimensional objects) and send three dimensional renditions of the three dimensional images.

For example, the user can use on-line art tools for creating original or custom artwork via a computer such as one of the client devices 20. The user can access a website by entering an access code to gain access to the website. The website includes software programs that simulate, drive and allow the user to manipulate icons or tools, artforms and/or materials for creating the original or custom artwork on-line. The on-line tools, the artforms and/or the materials for creating the original or custom artwork on-line include, but are not limited to, on-line forms of paints, paint brushes, crayons, markers, color palettes (e.g., a display of a complete range of colors made available by a computer graphics card, from which the user or a computer program may choose those to be displayed), shapes, graphics and images. The website includes a catalog of the on-line tools, the artforms and/or the materials for creating the original or custom artwork, for selection by the user.

In one embodiment, the on-line art tools include software for transforming the artwork or images into a three dimensional object or body or into an electronic image having a three dimensional appearance, such as that disclosed in commonly owned U.S. patent application Ser. No. 13/409,781, entitled System and Method for Transformation and Animation of Images, filed Mar. 1, 2012, which is herein incorporated by reference in its entirety. In one embodiment the interactive module 164 includes, a transformation subsection 164T for transforming the artwork and images into a three dimensional physical body or object. In one embodiment, the transformation subsection 164T is operatively coupled to a printer which creates a three dimensional object based on and representative of the artwork and/or image. In addition, the transformation subsection 164T is operatively coupled to, for example, a device for creating a digital rendering of the modified image with three dimensional appearances. The transformation subsection 164T is configured to enable the user to select images of such as, but not limited to, human or animal body parts (e.g., arms, legs, necks and torsos), structural components (frames, ship hulls, windows, doors and chimneys) and assembly them to form a three dimensional body or structure. In addition, the transformation subsection 164T is configured to enable the user to select clothing and dress or undress the three dimensional body. The three-dimensional bodies or structures can be used as memorabilia, toys, figurines, promotional material and/or a collectible item. In one embodiment, the transformation subsection 164T is configured to create audio and video recordings, transmit the recordings via electronic data transmission (e.g., e-mail, mobile phone), copy the audio and video recordings on suitable electronic media (e.g., DVDs, CDs, flash drives, etc.) and create website links for the audio and video recordings accessible through and over the network 60 (e.g., the internet).

In one embodiment, the interactive module 164 includes a module 164S for initiating a search for content of interest to the user. In one embodiment, the content search module 164S receives input from the user identifying specific content of interest that the user wishes to locate, and in another embodiment, the content search module 164S determines or “learns” content to be periodically later located based upon previous searches performed by the user. In effect, the content searches are undertaken based on specified or determined preferences for the user. In one embodiment, the system 10 may employ the user's profile to locate content of interest based on preferences of similar or “like” users. For example, if a user identifies him/her self as a sports enthusiast, then the content search module 164S may locate and present sport themed content when a search is requested.

In one embodiment, as noted above, the financial module 165 includes the virtual on-line store 165V, which can be used for distributing, trading, collecting, buying and/or selling the electronic representations of the memorabilia 12, including but not limited to the three dimensional objects and the electronic representations of the memorabilia 12 having a three dimensional appearance. The virtual on-line store 165V includes software (not shown) configured to establish a store name, domain name and URL, add serial numbers to the electronic representations of the memorabilia 12, control the number of and time at which the electronic representations of the memorabilia 12 are available for sale and collect and distribute proceeds from such sales to a plurality of entities. The virtual on-line store 165V is in communication with one or more websites (e.g., www.artstamps.com) to leverage sales of the electronic representations of the memorabilia 12.

The interactive module 164 also includes a module for users to request and pay for elaborate design of a personal electronic museum or STORYBOX™ location 82 (e.g., multiple architectural designs, colors, patterns, floor plans, number of floors, landscape, internal decorations, etc,) expanded electronic storage and downloading specialized online art tools.

In one embodiment, the financial module 165 includes the fundraising module 165F and the retail module 165R. The fundraising module 165F is configured to interact with non-profit organizations or other entities for the management and generation of income. In one embodiment, the fundraising module 165F includes an advertising module for linking to and/or creating advertising for fundraising or other purposes. For example, the fundraising module 165F includes fundraising systems and method such as, but not limited to, those defined in the copending and commonly owned U.S. patent application Ser. No. 12/975,928, filed Dec. 22, 2010.

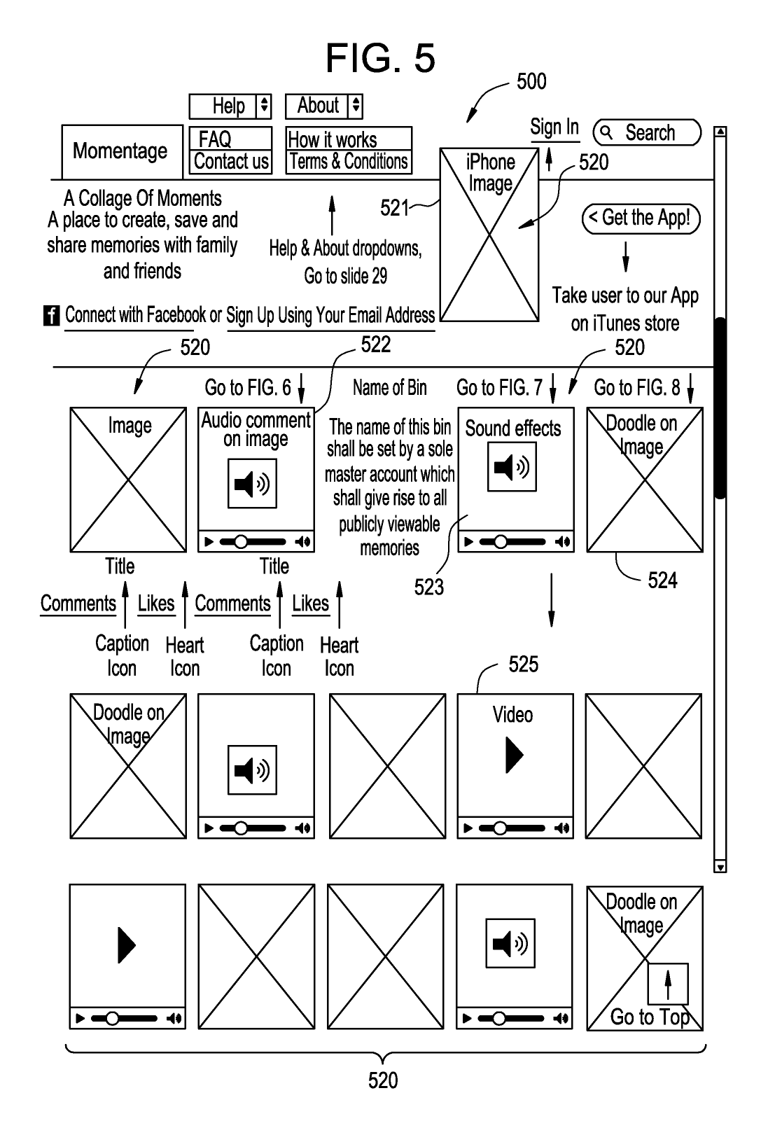

The retail module 165R is configured to establish a portal or website for on-line retail transactions, of memorabilia management services and products stemming therefrom. For example, all or portions of the data store 80 or STORYBOX™ locations 82 may be purchased, sold or traded or sent as gifts via the retail module 165R. As illustrated in FIG. 1, the MMA 24A and 44A provide an MMA log-in user interface (UI) 100 as an input-output mechanism to the memorabilia 12 within the memorabilia management system 10. The MMA log-in UI 100 is initially exhibited on the display devices 34 and/or 54 of one the client devices 20 and/or server 40 (e.g., as one of the user interfaces 34A and 54A). As can be appreciated, the memorabilia management system 10 is accessible by authorized persons referred to as users. In one embodiment, it is envisioned that users of the memorabilia management system 10 include, but are not limited to, subscribers and members that pay a fee for access to the memorabilia management system 10. Each user is provided a user identification (e.g., user ID) and password that is inputted to the MMA log-in UI 100, via a login page navigatable from a home page 500 (FIG. 5) of an MMA website to invoke operations of the memorabilia management system 10. As described herein, the subscribers and/or members of the memorabilia management system 10 employ the memorabilia management system 10 to monitor and manage their activities relating to the uploading, editing, commenting on, sharing, displaying, arranging, performing and transmitting the memorabilia 12 including the still images, audio, video recordings and combinations thereof. Memorabilia management system administrators may perform memorabilia management system maintenance such as, for example, add, change and delete subscribers or members from memorabilia management system 10, run summary and statistical reports of system utilization and the like.

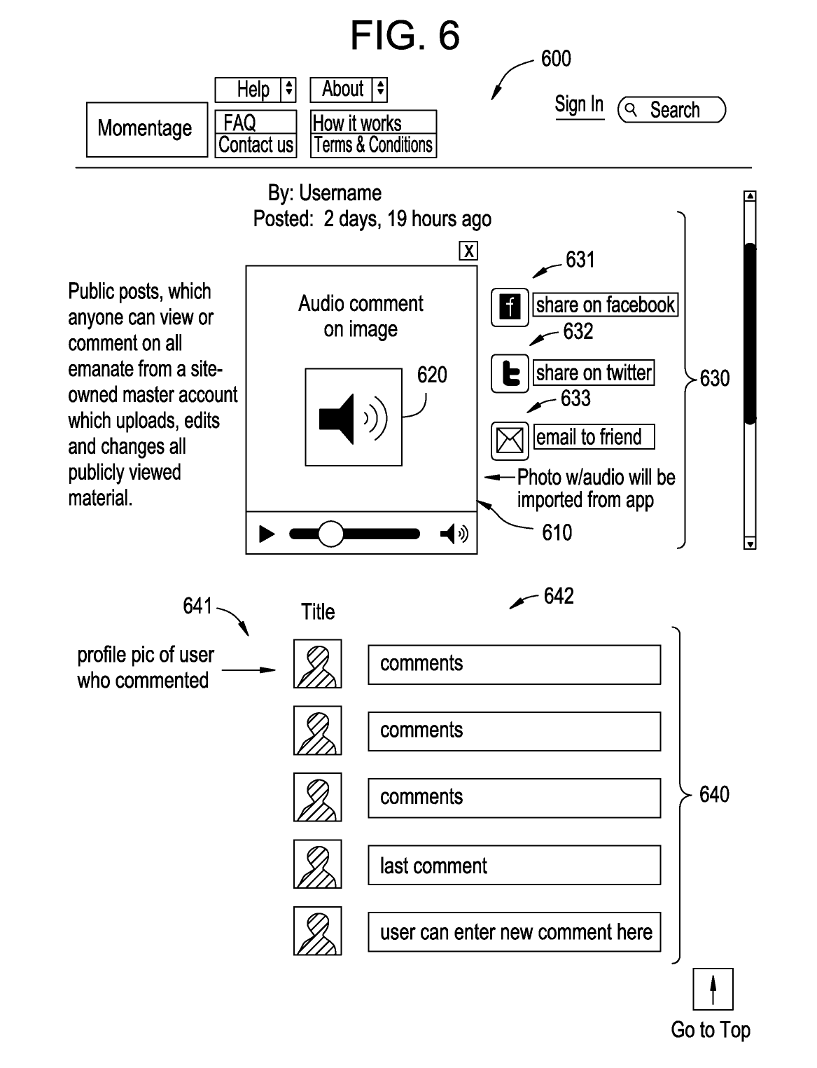

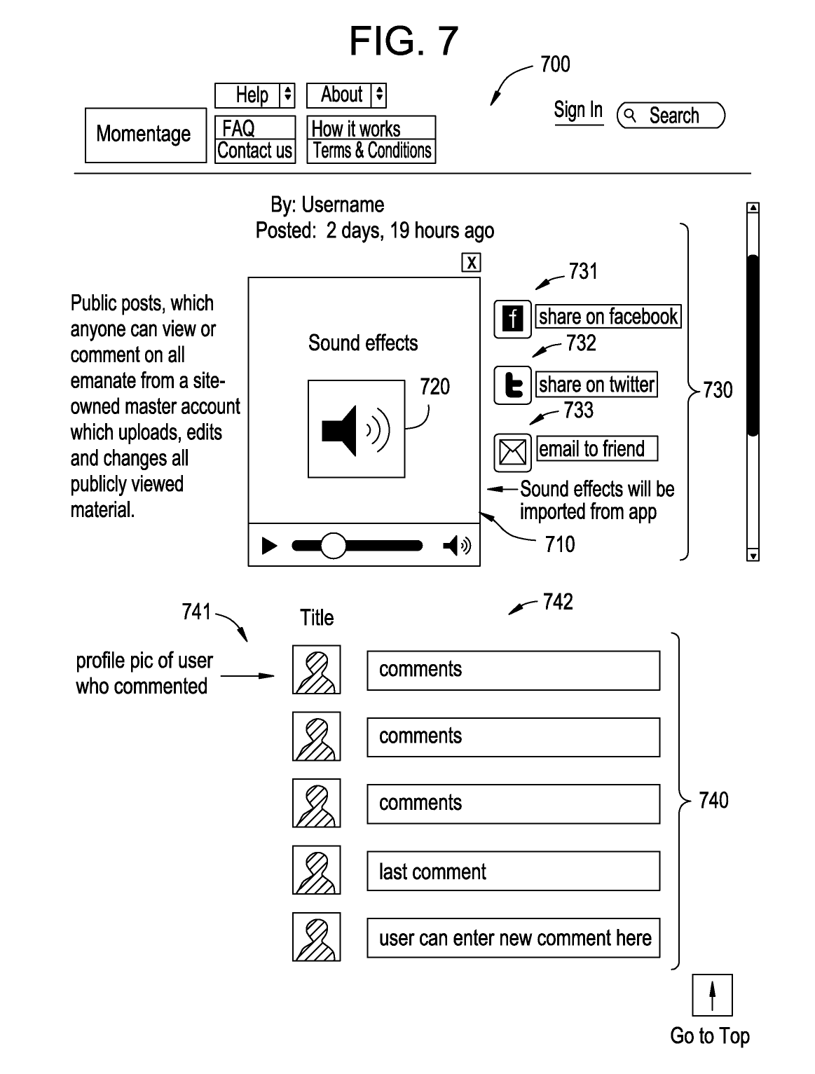

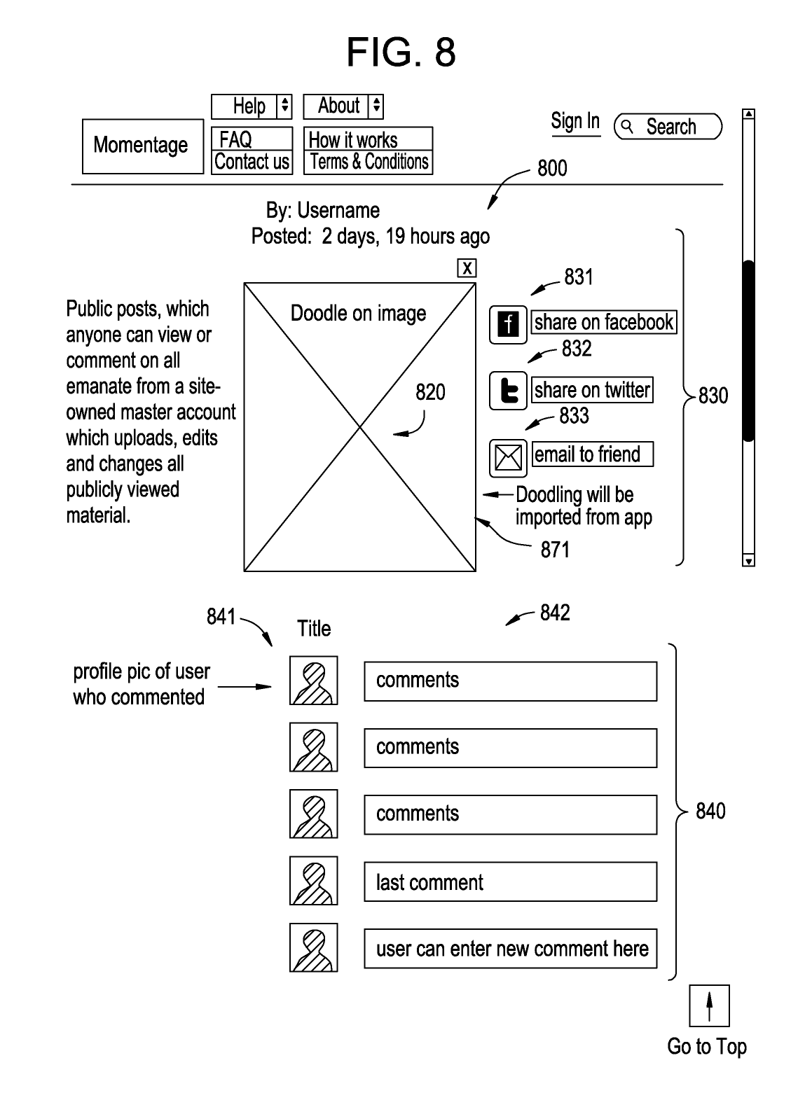

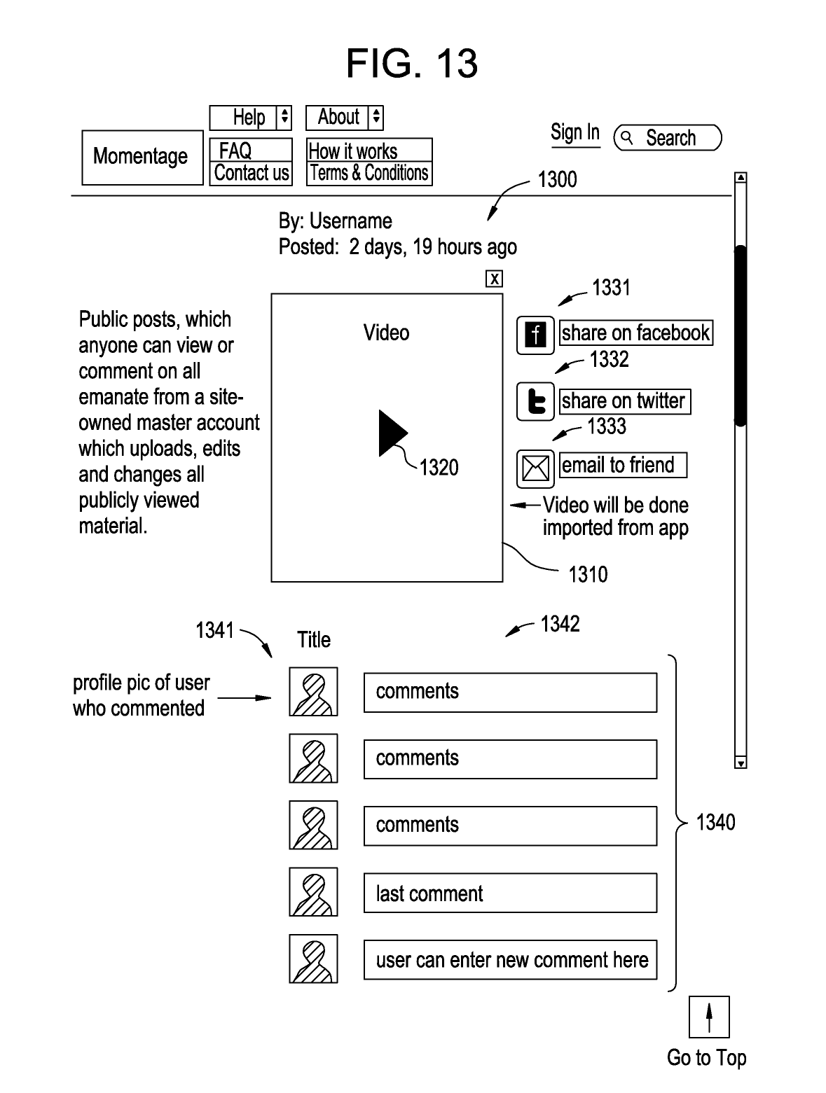

Once the log-in process is complete, users are directed to one or more user interfaces of the memorabilia management system 10. For example, FIG. 5 depicts the home page as a navigation page “dashboard” 500 which is presented to a user on one of the client devices 20 and/or the server 40. The dashboard 500 is presented on a webpage accessible via the internet. In one embodiment, the dashboard 500 is accessible and fully operational via an Application (i.e., App. or software application) installed on one of the client devices 20 such as a mobile computing device including a mobile telephone, for example, an I-phone or other smart phone device. The dashboard 500 presents a plurality of access controls collectively referred to with the element number 520 that, when selected, invoke a more detailed input, process, navigation to another web page or control user interfaces, for initiating one or more features and functions of the memorabilia management system 10 as described herein. For example, in one embodiment, the access controls 520 include: (1) login navigation button 521; (2) an audio comment on image navigation button 522; (3) a sound effects navigation button 523; (4) a doodle on image navigation button 524; and (5) a video effects navigation button 525. The login navigation button 521 links a user to a login page for entry of a user identification and password to gain access to the memorabilia management system 10, a camera, the cloud storage device 111, a smart phone, an I-phone, the client device 20 or the server 40 for automatically or manually uploading still images (e.g., photographs, digitized artwork, etc.), audio and video recordings. The audio comment on image navigation button 522 links a user to an audio comment on image webpage 600 as shown in FIG. 6, and described further below. The sound effects navigation button 523 links a user to a sounds effects webpage 700 as shown in FIG. 7, and described further below. The doodle on image navigation button 524 links the user to a doodle on image webpage 800 as shown in FIG. 8, and described further below. The video effects navigation button 525 links the user to a video effects webpage 1300 as shown in FIG. 13, and described further below.

As shown in FIGS. 6-8, the still images (e.g., photographs, digitized artwork, etc.), audio and video recordings may be modified at the webpages 600, 700 and 800. Once entered and/or modified, the still images (e.g., photographs, digitized artwork, etc.), audio and video recordings are stored by the memorabilia management system 10 such as, for example, as records within the data store 80 or one of the STORYBOX™ locations 82 and/or MOMENTS™ included therein. It should be appreciated that while specific examples follow that describe modifying the electronic representations of memorabilia 12 in certain ways within the system 10, it is within the scope of the present invention to broadly permit modification, annotating, commenting and/or otherwise editing the electronic representations of memorabilia 12. Accordingly, the following description is exemplary and not limiting to aspects of the present invention.

Referring to FIG. 6, the audio comment on image webpage 600 includes a still image window 610 in which the memorabilia 12 includes an image, such as a photograph, that is uploaded or imported via an MMA App from the client device 20 or the server 40, and is displayed in the window 610. The audio comment on image webpage 600 includes a sound recording button 620 which is activatable by clicking thereon to record sounds such as voice messages and/or music at the discretion of the user to annotate and/or memorialize the still image memorabilia 12 with the sound recording. The audio comment on image webpage 600 includes activation buttons 630 (e.g., a Facebook® button 631, a Twitter® button 632 and an e-mail button 633), for sharing the still image with or without the sound recordings and for authorizing and granting private and/or public access for others to comment on and record sounds relating and electronically tagged and linked to the still image. The audio comment on image webpage 600 includes a comment log 640 that identifies users who commented on (e.g., added sound recordings to) one or more particular still images. The comment log 640 includes a profile information section 641 for providing and displaying information about the person who commented on the still image. The comment log 640 also includes buttons 642 which link the user to and activate the sound recording and/or comment made by the persons commenting on the still image.

Referring to FIG. 7, the sound effects webpage 700 includes a still image window 710 in which the memorabilia 12 including an image, such as a photograph, is uploaded or imported via an MMA App from the client device 20 or the server 40, and displayed in the window 710. The sound effects webpage 700 includes a sound recording button 720 which is activatable by clicking thereon to record sounds such as prerecorded sounds accessible from an electronic library, database or pull-down menu and include sounds such as but not limited to music, chimes, alarms, horns, buzzers and the like at the discretion of the user to annotate and/or memorialize the still image with the sound recording. The sound effects webpage 700 includes activation buttons 730 (e.g., a Facebook® button 731, a Twitter® button 732 and an e-mail button 733), for sharing the still image with or without the sound recordings and for authorizing and granting private and/or public access for others to comment on and record sounds relating and electronically tagged and linked to the still image. The sound effects webpage 700 includes a comment log 740 that identifies users who commented on (e.g., added sound recordings to) one or more particular still images. The comment log 740 includes a profile information section 741 for providing and displaying information about the person who commented on the still image. The comment log 740 also includes buttons 742 which link the user to and activate the sound recording and or comment made by the persons commenting on the still image.

Referring to FIG. 8, the doodle on image webpage 800 includes a still image window 810 in which the memorabilia 12 including an image, such as a photograph, is uploaded or imported via an MMA App from the client device 20 or the server 40, and displayed in the window 810. The doodle on image webpage 800 includes a doodle on image button 820 which is activatable by clicking thereon to alter the image by electronically doodling on the still image (e.g., drawing eyebrows, facial hair, a tail or large ears on the still image, adding a user's personal signature to the still image, handwriting notes or marks on the still image) at the discretion of the user to annotate and/or memorialize the still image with the doodle. The electronic doodling on the still image includes use of electronic pens and paint brushes and on-line tools, artforms and/or the materials for creating the original or custom artwork or text such as, but are not limited to, on-line forms of paints, paint brushes, crayons, markers, color palettes (e.g., a display of a complete range of colors made available by a computer graphics card, from which the user or a computer program may choose those to be displayed), shapes, graphics and images, as described in commonly owned and copending U.S. patent application Ser. No. 12/975,928, filed Dec. 22, 2010 and its priority applications as described in the Cross Reference to Related Applications section of the present application. The doodle on image webpage 800 includes activation buttons 830 (e.g., a Facebook® button 831, a Twitter® button 832 and an e-mail button 833), for sharing the still image with or without the doodles and for authorizing and granting private and/or public access for others to comment on and create doodles on the still images which are electronically tagged and linked to the still image. The doodle on image webpage 800 includes a comment log 840 that identifies users who commented on (e.g., doodled on) one or more particular still images. The comment log 840 includes a profile information section 841 for providing and displaying information about the person who commented on (e.g., doodled on) the still image. The comment log 840 also includes buttons 842 which link the user to and activate the doodled on image and or comment made by the persons commenting on the still image.

Referring to FIG. 13, the video effects webpage 1300 includes a still image window 1310 in which the memorabilia 12 including an image, such as a photograph, is uploaded or imported via an MMA App from the client device 20 or the server 40, and displayed in the window 1310. The video effects webpage 1300 includes a video recording button 1320 which is activatable by clicking thereon to record videos such as prerecorded videos accessible from an electronic library, database or pull-down menu and includes videos such as, but not limited to, movies, home video clips, I-phone video clips, television news recordings and the like, at the discretion of the user to annotate and/or memorialize the still image with the video recording. The video effects webpage 1300 includes activation buttons 1330 (e.g., a Facebook® button 1331, a Twitter® button 1332 and an e-mail button 1333), for sharing the still image with or without the video recordings and for authorizing and granting private and/or public access for others to comment on and record video relating and electronically tagged and linked to the still image. The video effects webpage 1300 includes a comment log 1340 that identifies users who commented on (e.g., added video recordings to) one or more particular still images. The comment log 1340 includes a profile information section 1341 for providing and displaying information about the person who commented on the still image. The comment log 1340 also includes buttons 1342 which link the user to and activate the video recording and or comment made by the persons commenting on the still image.

It should be appreciated that the aforementioned description of activities for sharing electronic representations of memorabilia 12 on platforms such as, for example, Facebook®, Twitter® and e-mail include a transfer of a plurality of the electronic representations of memorabilia 12 and/or a transfer of a composite representation of the plurality of the electronic representations of memorabilia 12 (e.g., an individual graphical object of the plurality) in standardized formats such as, for example, the aforementioned HTML, XML or other SGML formats, as are generally known in the art.

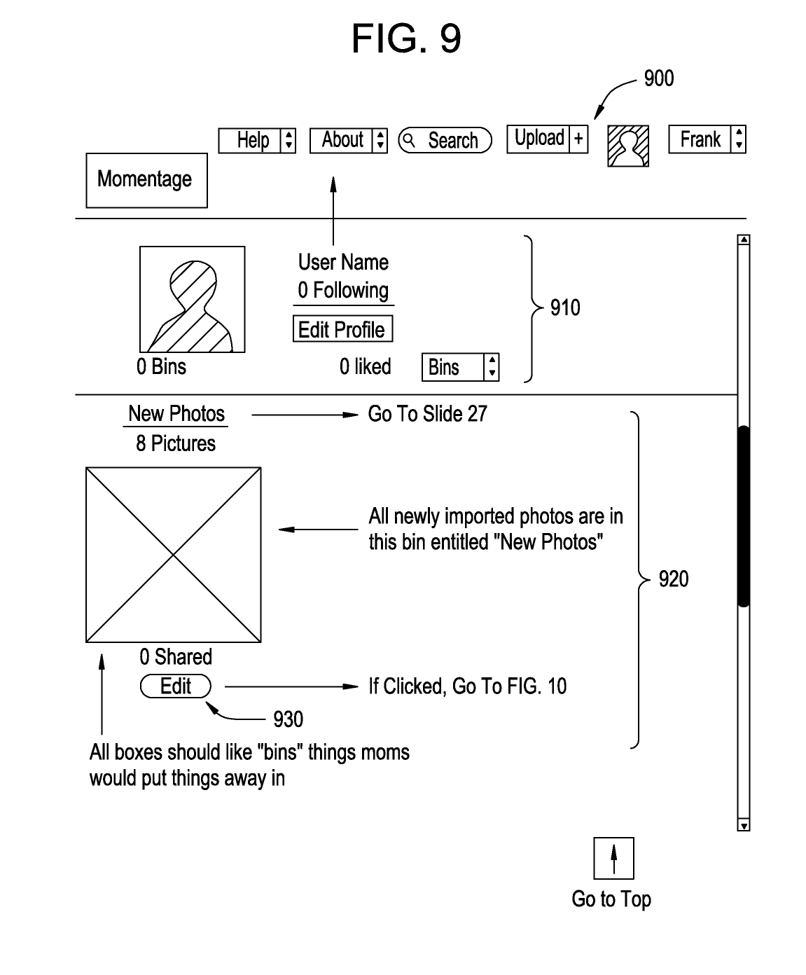

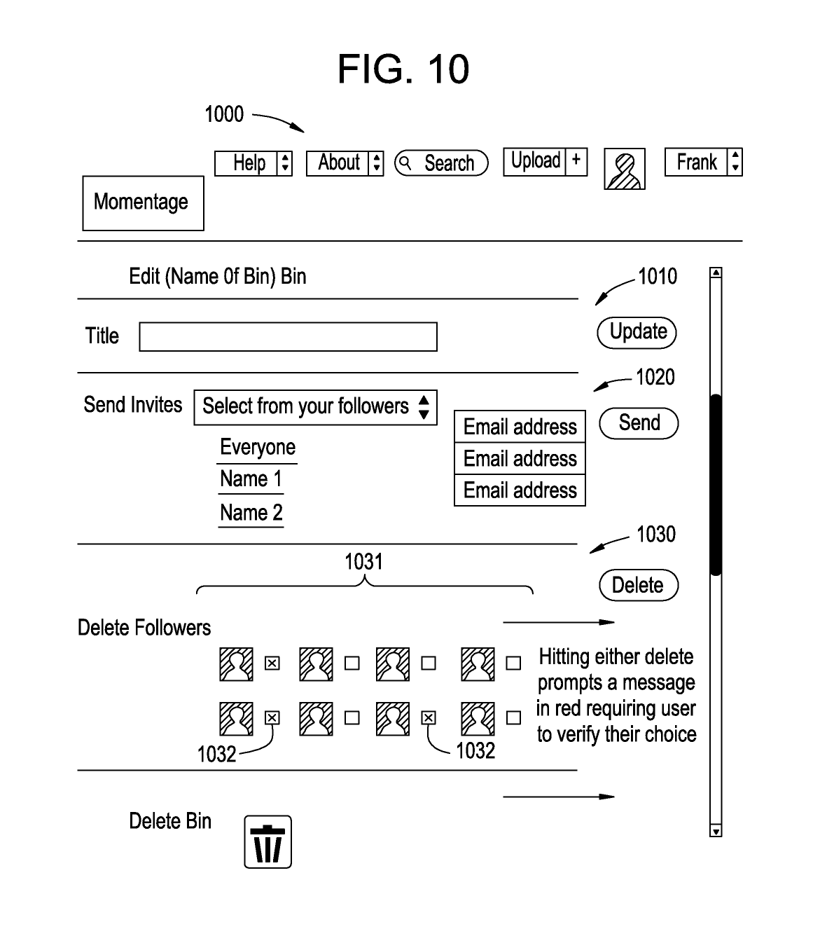

Referring to FIG. 9, an image uploading web page 900 includes a user profile section 910 which is configured to enable users to input and edit their profile information including access levels for viewers and establishing share lists to the electronic representations of memorabilia 12 that the user has added to the system 10. The image uploading web page 900 also includes a new image uploading section 920 which includes links to sources of electronic representations of the memorabilia 12 including photos, videos, and audio recordings and a link to the data store 80. The image uploading web page 900 further includes an edit button 930 which links the user to a create and edit web page 1000 (see FIG. 10) for creating, naming and editing storage bins such as the STORYBOX™ locations 82 and/or the MOMENTS™ included therein.

Referring to FIG. 10, the create and edit web page 1000 includes a first field 1010 for assigning a name or title to the STORYBOX™ locations 82 and/or the MOMENTS™ included therein, for example, sports, baby, school, etc. The create and edit web page 1000 also includes a second field 1020 for identifying and selecting invitees and inputting addresses of invitees (e.g., e-mail addresses). The create and edit web page 1000 further includes a follower status and edit section 1030 which includes a list of followers 1031 and buttons 1032 for deleting followers (e.g., terminating followers access to the STORYBOX™ locations 82 and/or the MOMENTS™ included therein).

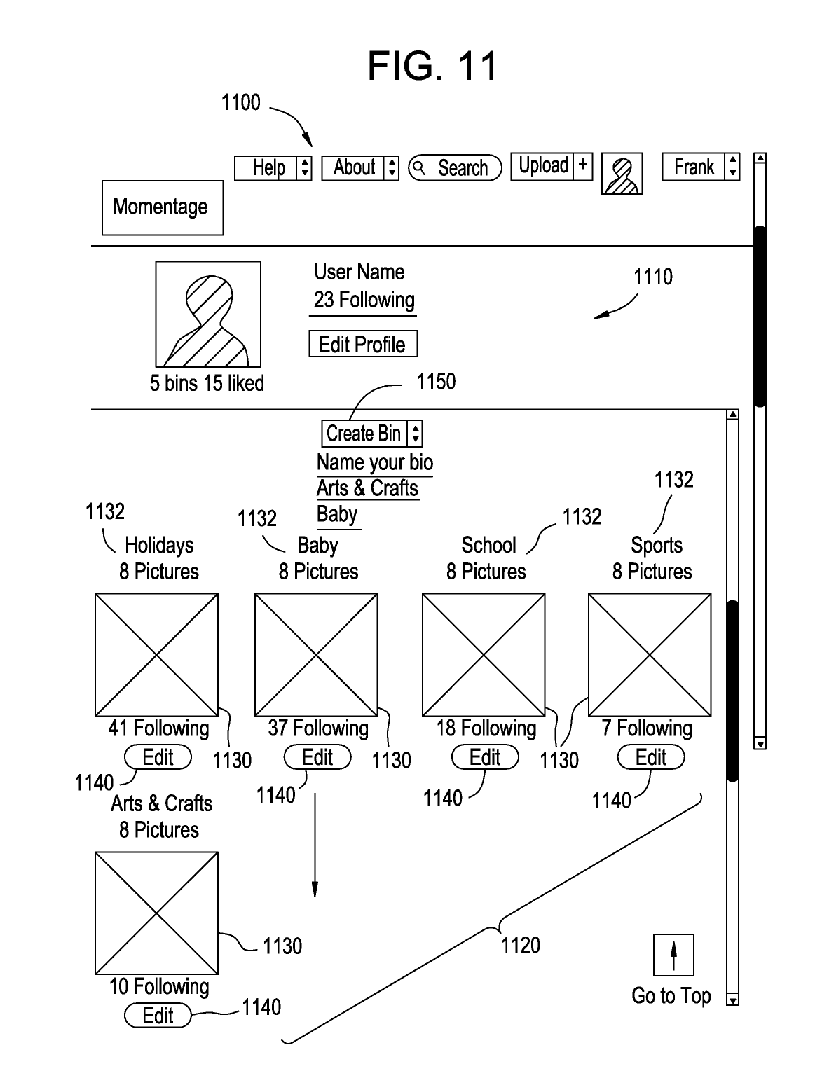

Referring to FIG. 11, a STORYBOX™ 82 summary web page 1100 includes a user profile section 1110 which is configured to enable users to input and edit their profile information including access levels for viewers and establishing share lists to the electronic representations of memorabilia 12 that the user has added to the system 10. The STORYBOX™ 82 summary web page 1100 includes a storage bin management section 1120 which includes a plurality of icons 1130 having indicia 1132 relating to the category of the contents of the respective bin or STORYBOX™ location 82. In one embodiment, the indicia includes a user definable name, tag or label identifying the contents of the STORYBOX™ location 82 as well as an indication of the quantity of items included therein. Each of the icons 1130 is operative as a clickable button that causes the contents (e.g., still images, video and audio recordings) in the bin (e.g., the STORYBOX™ location 82) to be downloaded from the data store 80 and displayed, for example in a particular bin or STORYBOX™ webpage 1200 as shown in FIG. 12. The storage bin management section 1120 includes edit buttons 1140 for editing the content, name, icons 1130. The storage bin management section 1120 also includes a button 1150 which is operative to link to the create and edit web page 1000 illustrated in FIG. 10. As shown in FIG. 12, the STORYBOX™ webpage 1200 includes a storage bin management section 1220 which includes a plurality of icons 1210 which are operative as links to download and display the electronic representations of memorabilia 12 including the still images, video and audio recordings from the data store 80. The storage bin management section 1220 also includes a play button 1230 which is configured to download and display the electronic representations of memorabilia 12 including the still images, video and audio recordings from the data store 80 in chronological order or in a predetermined order upon the demand of the user or automatically based upon a trigger (e.g., at date and time, or upon detection of one or more predetermined names or addresses of a visitor or follower). In one embodiment, illustrated in FIG. 12A, the STORYBOX™ webpage 1200 presents the electronic representations of memorabilia 12 including the still images, video and audio recordings from a selected one of the STORYBOX™ locations 82 as the plurality of icons 1220 in a first format as well as in one of the template formats 162T such as a grid 1250 of icons 1260 including a first icon 1262 that is presented as an enlarged icon as compared to the remaining icons 1264 such that all of the electronic representations of the memorabilia 12 within the STORYBOX™ location 82 and/or MOMENTS™ therein are exhibited and viewable to the user. It should be appreciated that the presentation of the electronic representations of memorabilia 12 within one or more STORYBOX™ webpages 1200 may be user definable, for example, such that a combined view is presented as shown in FIG. 12A, individual icons are presented as shown in FIG. 12, or only the template or grid view is shown.

Referring again to FIG. 1, in one embodiment, the MMA 24A, 44A is in communication with a social media system 169 (e.g., FACEBOOK®, TWITTER®) via the network 60. For example, the MMA 24A, 44A and the social media system 169 exchange information and the electronic representations of the memorabilia 12 including the images, video recordings, audio recordings stored in the system 10, via the network 60. In one embodiment, the retail module 165R is in communication with the social media system 169 (e.g., FACEBOOK®, TWITTER®) via the network 60. The retail module 165R is configured to present a tiered pricing structure for purchase of the products and services offered through the memorabilia management system 10. For example, individual tiers and pricing are defined for access to and utilization of the audio comment on image webpage 600, the sounds effects webpage 700, the doodle on image webpage 800, and/or the video effects webpage 1300.

Although the invention has been described with reference to particular embodiments thereof, upon a reading and understanding of the foregoing disclosure, it will be understood by one of ordinary skill in the art that numerous variations and alterations to the disclosed embodiments will fall within the scope of this invention and of the appended claims.

What is claimed is:

1. A computer based system for management of memorabilia, the system comprising:
a processor coupled to memory and an input-output controller;
a data store in communication with the processor;
an input device coupled to the input-output controller;
a display device coupled to the input-output controller;
the memory including at least one algorithm comprising:
an initial processing section configured to upload a plurality of first images and first audio files having a plurality of data file formats;
an organization and storage section configured to determine at least one location within the data store for storing each of the plurality of first images and first audio files; and
an access and display section configured for at least one of creating, retrieving, viewing, moving, annotating and transmitting the plurality of first images and first audio files, the access and display section being configured to add at least one of an additional image and an additional audio file onto the at least one of the plurality of first images and first audio files.

2. The computer based system of claim 1, wherein the initial processing section is configured to upload the plurality of first images and first audio files coincident with a point-of-capture of at least one of the plurality of first images and first audio files, by at least one of a camera, a scanner and a recorder.

3. The computer based system of claim 1, wherein the access and display section is configured to display the plurality of first images and first audio files in response to execution of a single command.

4. The computer based system of claim 1, wherein the access and display section is configured to selectively transmit at least one of the plurality of first images and first audio files to at least one predetermined receiver.

5. The computer based system of claim 1, wherein the initial processing section is configured to communicate with and receive the plurality of first images and first audio from at least two sources.

6. The computer based system of claim 1, wherein the initial processing section is configured to communicate with and receive the plurality of first images and first audio file from at least two sources, simultaneously.

7. The computer based system of claim 1, wherein the data store comprises a cloud device accessible from a plurality of locations.

8. The computer based system of claim 1, wherein the access and display section is configured to enable users to create at least one of two and three dimensional renditions of at least one of the plurality of first images.

9. The computer based system of claim 1, wherein the at least one algorithm is an application operable on a mobile telephone.

10. The computer based system of claim 1, wherein the at least one algorithm is operable on a website.

11. The computer based system of claim 1, wherein the access and display section is configured to host a virtual on-line store for at least one of fundraising and retail transactions.

12. The computer based system of claim 1, wherein the organization and storage section is configured determine at least one location within the data store for storage of each of the plurality of first images and first audio files coincident with the point-of-capture of the images and audio files, by at least one of a camera, a scanner and a recorder.

13. The computer based system of claim 1, wherein the first images include at least one of videos, photographs and artwork.

14. The computer based system of claim 1, wherein the at least one algorithm is in communication with a social media system.

15. The computer based system of claim 1, wherein the access and display section includes a selection module having a viewer operated button to activate the adding of the additional images and additional audio files.

16. The computer based system of claim 14, wherein the at least one algorithm includes a user operated button for activation of sharing at least one of the plurality of first images and first audio files with others via the social media system.

17. The computer based system of claim 1, further comprising on-line software for transforming the first images into three dimensional objects.

18. The computer based system of claim 1, wherein the at least one additional image is added onto the first audio file.

19. The computer based system of claim 1, wherein the at least one additional audio file is added onto the first image.

20. The computer based system of claim 1, further comprising a mobile client device configured to access a website via an application, the application being configured to communicate with the access and display section to cause the adding of the at least one of an additional image and an additional audio file onto the at least one of the plurality of first images and first audio files.
